(19) United States
(12) Patent Application Publication
(10) Pub. No.: US 2026/0161138 A1
(43) Pub. Date: Jun. 11, 2026

(54) SYSTEM FOR DETECTING DIRECTION OF MOVEMENT, WEARABLE ELECTRONIC DEVICE, AND METHOD FOR DETECTING DIRECTION OF MOVEMENT IN SAID SYSTEM AND SAID WEARABLE ELECTRONIC DEVICE

(71) Applicant: Samsung Electronics Co., Ltd., Suwon-si (KR)

(72) Inventors: Jinik KIM, Suwon-si (KR); Namjoon PARK, Suwon-si (KR)

(21) Appl. No.: 19/180,467

(22) Filed: Apr. 16, 2025

Related U.S. Application Data
(63) Continuation of application No. PCT/KR2023/015636, filed on Oct. 11, 2023.

(30) Foreign Application Priority Data
Nov. 11, 2022 (KR) 10-2022-0150079
Dec. 5, 2022 (KR) 10-2022-0167558

(51) Int. Cl. G04G 21/02; G01C 21/16; G04B 47/06

(52) U.S. Cl. CPC G04G 21/025; G01C 21/16; G04B 47/063

(57) ABSTRACT

A wearable electronic device is provided. The wearable device includes a sensor module, a location measurement module, a communication module, memory storing one or more computer programs, and one or more processors communicatively coupled to the sensor module, the location measurement module, the communication module, and the memory, wherein the one or more computer programs include computer-executable instructions that, when executed by the one or more processors individually or collectively, cause the wearable electronic device to, when identifying execution of a location-based application, request an external wearable electronic device communication-connected through the communication module to calculate posture information about the external wearable electronic device, when identifying that a reception sensitivity of a location signal received from the location measurement module is equal to or less than a threshold level during detection of a movement direction of the wearable electronic device based on the location signal, request the posture information about the external wearable electronic device from the external wearable electronic device, and detect the movement direction of the wearable electronic device by applying the posture information received from the external wearable electronic device to pedestrian dead reckoning.

### CROSS-REFERENCE TO RELATED APPLICATION(S)

This application is a continuation application, claiming priority under 35 U.S.C. § 365 (c), of an International application No. PCT/KR2023/015636, filed on Oct. 11, 2023, which is based on and claims the benefit of a Korean patent application number 10-2022-0150079, filed on Nov. 11, 2022, in the Korean Intellectual Property Office, and a Korean patent application number 10-2022-0167558, filed on Dec. 5, 2022, in the Korean Intellectual Property Office, the disclosure of each of which is incorporated by reference herein in its entirety.

### BACKGROUND

### 1. Field

The disclosure relates to a system for detecting a movement direction, a wearable electronic device, and a method of detecting a movement direction in the system and the wearable electronic device.

### 2. Description of Related Art

Recently, the number of users who exercise using only smart watches and earbuds is increasing. A smart watch may include a communication module to transmit and receive data independently and further include a 9-axis sensor and a global navigation satellite system (GNSS) module to support a user's exercise path information. However, the smart watch may have lower antenna performance for receiving a location signal through the GNSS module than a smartphone due to limitations in its hardware size, and have a decreased reception sensitivity and location accuracy performance of a location signal received through the GNSS module due to interference between devices. Moreover, in an environment, such as indoors or a tunnel, the reception sensitivity of the location signal received through the GNSS module may decrease, making it difficult to provide accurate information, when a user's exercise trajectory is provided.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system for detecting a movement direction, a wearable electronic device, and a method of detecting a movement direction in the system and the wearable electronic device.

Additional aspects will be set forth in part in the description which follows and, in part, will be apparent from the description, or may be learned by practice of the presented embodiments.

In accordance with an aspect of the disclosure, a wearable electronic device is provided. The wearable device includes a sensor module, a location measurement module, a communication module, memory storing one or more computer programs, and one or more processors communicatively coupled to the sensor module, the location measurement module, the communication module, and the memory, wherein the one or more computer programs include computer-executable instructions that, when executed by the one or more processors individually or collectively, cause the wearable electronic device to, when identifying execution of a location-based application, request an external wearable electronic device communication-connected through the communication module to calculate posture information about the external wearable electronic device, when identifying that a reception sensitivity of a location signal received from the location measurement module is equal to or less than a threshold level during detection of a movement direction of the wearable electronic device based on the location signal, request the posture information about the external wearable electronic device from the external wearable electronic device and detect the movement direction of the wearable electronic device by applying the posture information received from the external wearable electronic device to pedestrian dead reckoning.

In accordance with another aspect of the disclosure, a system for detecting a movement direction is provided. The system includes a first wearable electronic configured to when identifying execution of a location-based application, request a communication-connected second wearable electronic device to calculate posture information about the second wearable electronic device, when identifying that a reception sensitivity of a location signal received from a location measurement module of the first wearable electronic device is equal to or less than a threshold during detection of a movement direction of the first wearable electronic device based on the location signal, request the posture information about the second wearable electronic device from the second wearable electronic device, and detect the movement direction of the first wearable electronic device by applying the posture information received from the second wearable electronic device to pedestrian dead reckoning, and the second wearable electronic device configured to, when receiving the request for calculating the posture information about the second wearable electronic device from the first wearable electronic device, calculate the posture information about the second wearable electronic device based on a sensor module of the second wearable electronic device, and when receiving the request for the posture information about the second wearable electronic device from the first wearable electronic device, transmit the posture information about the second wearable electronic device to the first wearable electronic device.

In accordance with another aspect of the disclosure, a method of detecting a movement direction in a wearable electronic device is provided. The method includes, when identifying execution of a location-based application, requesting an external wearable electronic device communication-connected through a communication module of the wearable electronic device to calculate posture information about the external wearable electronic device, when identifying that a reception sensitivity of a location signal received from a location measurement module of the wearable electronic device is equal to or less than a threshold level during detection of a movement direction of the wearable electronic device based on the location signal, requesting the posture information about the external wearable electronic device from the external wearable electronic device, and detecting the movement direction of the wearable electronic device by applying the posture information received from the external wearable electronic device to pedestrian dead reckoning.

In accordance with another aspect of the disclosure, a method of detecting a movement direction is provided. The method includes when identifying execution of a location-based application, requesting a communication-connected second wearable electronic device to calculate posture information about the second wearable electronic device by a first wearable electronic device, when receiving the request for calculating the posture information about the second wearable electronic device from the first wearable electronic device, calculating the posture information about the second wearable electronic device based on a sensor module of the second wearable electronic device by the second wearable electronic device, when identifying that a reception sensitivity of a location signal received from a location measurement module of the first wearable electronic device is equal to or less than a threshold during detection of a movement direction of the first wearable electronic device based on the location signal, requesting the posture information about the second wearable electronic device from the second wearable electronic device by the first wearable electronic device, when receiving the request for the posture information about the second wearable electronic device from the first wearable electronic device, transmitting the posture information about the second wearable electronic device to the first wearable electronic device by the second wearable electronic device, and detecting the movement direction of the first wearable electronic device by applying the posture information received from the second wearable electronic device to pedestrian dead reckoning by the first wearable electronic device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include, when identifying execution of a location-based application, requesting a communication-connected second wearable electronic device to calculate posture information about the second wearable electronic device by a first wearable electronic device, when receiving the request for calculating the posture information about the second wearable electronic device from the first wearable electronic device, calculating the posture information about the second wearable electronic device based on a sensor module of the second wearable electronic device by the second wearable electronic device, when identifying that a reception sensitivity of a location signal received from a location measurement module of the first wearable electronic device is less than a threshold during detection of a movement direction of the first wearable electronic device based on the location signal, requesting the posture information about the second wearable electronic device from the second wearable electronic device by the first wearable electronic device, when receiving the request for the posture information about the second wearable electronic device from the first wearable electronic device, transmitting the posture information about the second wearable electronic device to the first wearable electronic device by the second wearable electronic device, and detecting the movement direction of the first wearable electronic device by applying the posture information received from the second wearable electronic device to pedestrian dead reckoning by the first wearable electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a diagram illustrating a system for detecting a movement direction according to an embodiment of the disclosure;

FIG. 3 is a block diagram illustrating a first wearable electronic device according to an embodiment of the disclosure;

FIG. 4 is a block diagram illustrating a second wearable electronic device according to an embodiment of the disclosure;

FIG. 5 is a diagram illustrating a time point for transmitting reference information in a wearable electronic device according to an embodiment of the disclosure;

FIGS. 6A and 6B are diagrams illustrating a time point for transmitting reference information in a wearable electronic device according to various embodiments of the disclosure;

FIGS. 7A, 7B, 7C, and 7D are diagrams illustrating an operation of detecting a movement direction using a step and heading system in a wearable electronic device according to various embodiments of the disclosure;

FIGS. 8A and 8B are diagrams illustrating an operation of providing various functions using a wearable electronic device according to various embodiments of the disclosure;

FIG. 9 is a flowchart illustrating an operation of detecting a movement direction in a wearable electronic device according to an embodiment of the disclosure;

FIG. 10 is a flowchart illustrating an operation of detecting a movement direction in a wearable electronic device according to an embodiment of the disclosure; and

FIG. 11 is a flowchart illustrating an operation of detecting a posture of a wearable electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

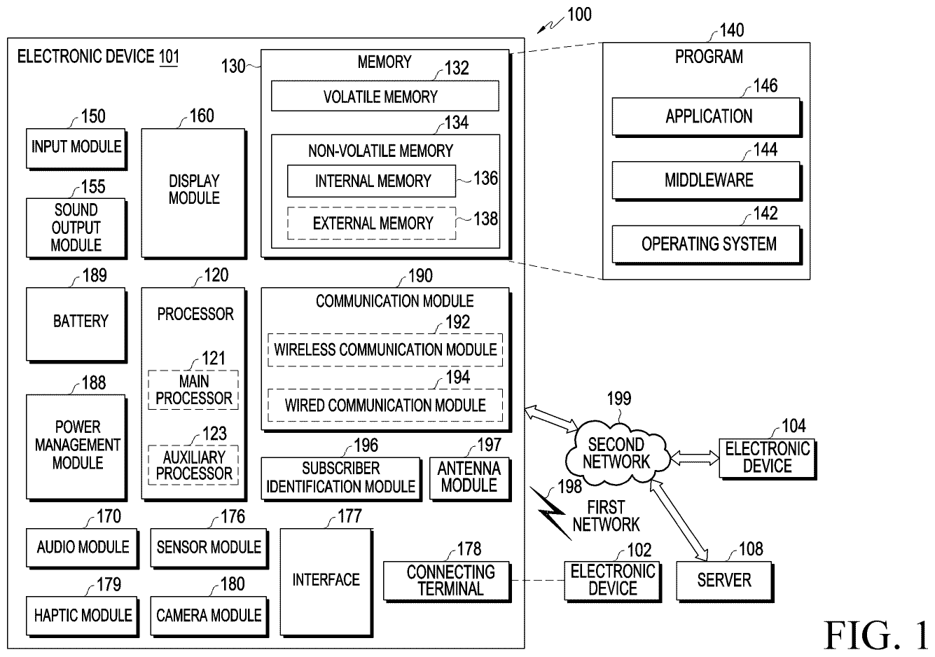

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the strength of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to an embodiment of the disclosure, the antenna module 197 may form an mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IOT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

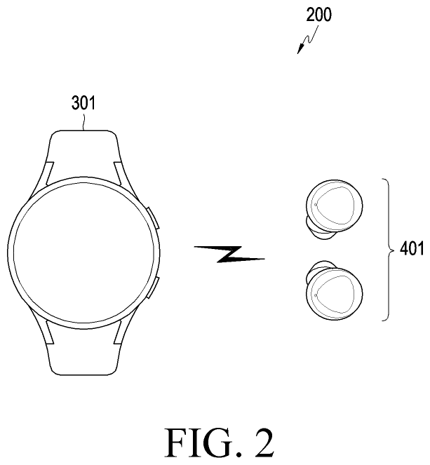

FIG. 2 is a diagram 200 illustrating a system for detecting a movement direction according to an embodiment of the disclosure.

Referring to FIG. 2, according to an embodiment of the disclosure, the system for detecting a movement direction may include a first wearable electronic device 301 and a second wearable electronic device 401.

According to an embodiment of the disclosure, the first wearable electronic device 301 may include a smart watch wearable on an arm of a user's body.

According to an embodiment of the disclosure, when the first wearable electronic device 301 identifies execution of a location-based application while being worn on the arm of the user's body, the first wearable electronic device 301 may identify a communication connection to the second wearable electronic device 401 worn on a part of the head of the user's body, and request the second wearable electronic device 401 to calculate posture information about the second wearable electronic device.

According to an embodiment of the disclosure, when the first wearable electronic device 301 identifies the execution of the location-based application while being worn on the arm of the user's body, the first wearable electronic device may detect a movement direction of the first wearable electronic device based on a location signal received from a location measurement module of the first wearable electronic device.

According to an embodiment of the disclosure, when the first wearable electronic device 301 identifies a time point for transmitting reference information for updating the posture information calculated by the second wearable electronic device 401 (e.g., when the posture of the first wearable electronic device is a first posture in which the user raises the arm wearing the first wearable electronic device and gazes at the first wearable electronic device, or when a movement velocity of the first wearable electronic device is equal to or greater than a threshold velocity) during detection of a movement direction of the first wearable electronic device based on the location signal received from the location measurement module of the first wearable electronic device, the first wearable electronic device 301 may transmit, to the second wearable electronic device 401, the reference information (e.g., absolute azimuth information) calculated based on a sensor signal obtained from a sensor module (e.g., a geomagnetic sensor) of the first wearable electronic device or the location signal obtained from the location measurement module of the first wearable electronic device.

According to an embodiment of the disclosure, when the first wearable electronic device 301 identifies that a reception sensitivity of the location signal received from the location measurement module of the first wearable electronic device is equal to or less than a threshold level, the first wearable electronic device 301 may request the posture information about the second wearable electronic device from the second wearable electronic device 401, and detect the movement direction of the first wearable electronic device 301 by applying the posture information about the second wearable electronic device received from the second wearable electronic device 401 to pedestrian dead reckoning (e.g., step and heading system (SHS)).

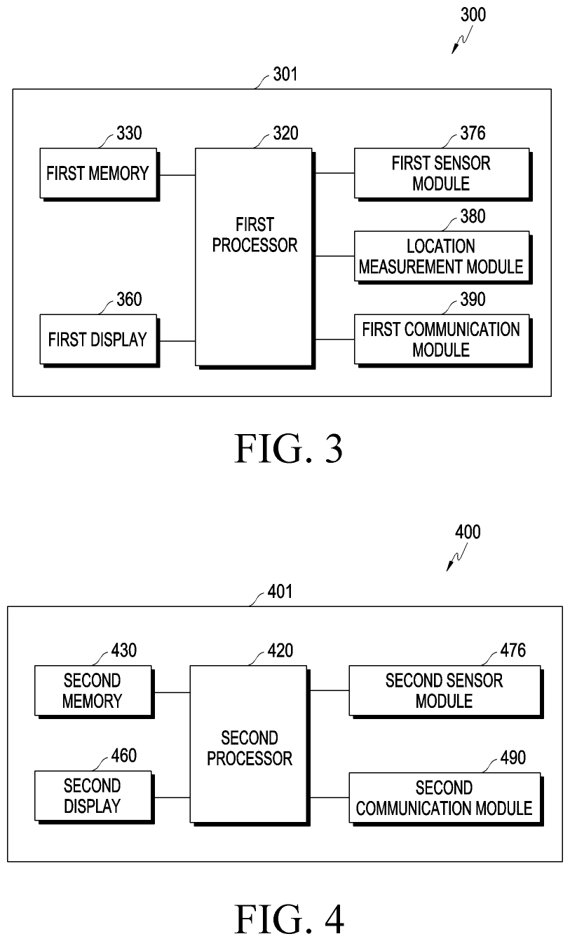

The configuration of the first wearable electronic device 301 will be described below in detail with reference to FIG. 3.

According to an embodiment of the disclosure, the second wearable electronic device 401, which is a wearable electronic device that may be worn on a part of the head of the user's body, may include, for example, earbuds and/or smart glasses.

According to an embodiment of the disclosure, while being worn on the part of the head of the user's body, the second wearable electronic device 401 may identify a communication connection to the first wearable electronic device 301 worn on the arm of the user's body, and when receiving a request for calculating posture information about the second wearable electronic device from the first wearable electronic device 201, may detect the posture information (e.g., relative azimuth information) about the second wearable electronic device 401 calculated based on a sensor signal obtained from a sensor module (e.g., an acceleration sensor and/or a gyro sensor) of the second wearable electronic device 401.

According to an embodiment of the disclosure, when the second wearable electronic device 401 receives, from the first wearable electronic device 301, reference information for updating the posture information calculated by the second wearable electronic device 4201 during detection of the posture information about the second wearable electronic device 401, it may update the posture information (e.g., the relative azimuth information) based on the reference information (e.g., absolute azimuth information) so that the reference information and the posture information substantially match.

The configuration of the second wearable electronic device 401 will be described below in detail with reference to FIG. 4.

FIG. 3 is a block diagram 300 illustrating a first wearable electronic device according to an embodiment of the disclosure.

Referring to FIG. 3, according to an embodiment of the disclosure, the wearable electronic device 301 (e.g., the first wearable electronic device 301 of FIG. 2) may include a first processor 320, first memory 330, a first display 360, a first sensor module 376, a location measurement module 380, and/or a first communication module 390.

At least some of the components of the wearable electronic device 301 illustrated in FIG. 3 may be identical or similar to the components of the electronic device 101 of FIG. 1, and a redundant description will be avoided below.

According to an embodiment of the disclosure, the first processor 320 may be implemented substantially the same as or similar to the processor 120 of FIG. 1.

According to an embodiment of the disclosure, when the first processor 320 identifies execution of a location-based application (e.g., the application 146 of FIG. 1), it may request an external wearable electronic device (e.g., the second wearable electronic device 401 of FIG. 2) communication-connected through the first communication module 390 to calculate posture information about the external wearable electronic device, and detect and record a movement direction of the wearable electronic device 301 based on a location signal received from the location measurement module 380.

According to an embodiment of the disclosure, when the first processor 320 identifies execution of a location-based application (e.g., an exercise application) requiring a movement trajectory, it may identify whether communication is connected to the external wearable electronic device 401, and when communication is connected to the external wearable electronic device 401, request the external wearable electronic device 401 to calculate posture information about the external wearable electronic device 401 through the first communication module 390.

According to an embodiment of the disclosure, while being communication-connected to the external wearable electronic device 401, when the first processor 320 identifies that the wearable electronic device 301 is worn on the arm of the user's body and receive, from the external wearable electronic device 401, status information indicating that the external wearable electronic device 401 is worn on the head of the user's body, it may request the external wearable electronic device 401 to calculate posture information about the external wearable electronic device 401 through the first communication module 390.

According to an embodiment of the disclosure, when the first processor 320 identifies that a time point is reached for transmitting reference information for updating the posture information calculated by the external wearable electronic device 401 (e.g., the second wearable electronic device 401 of FIG. 2), during detection of the movement direction of the wearable electronic device 301 based on the location signal received from the location measurement module 380, the first processor 320 may transmit the reference information calculated based on sensor information obtained from the first sensor module 376 or the location signal obtained from the location measurement module 380 to the external wearable electronic device.

According to an embodiment of the disclosure, when the first processor 320 detects the first posture of the wearable electronic device 301 in which the user lifts the arm wearing the wearable electronic device 301 and gazes at the first display 360 of the wearable electronic device 301 in a state where the wearable electronic device 301 is decreased in velocity or stationary, the first processor 320 may identify that a time point for transmitting the reference information to the external wearable electronic device 401 is reached. When the processor 320 identifies the first posture of the wearable electronic device 301, it may identify that this is a time point when a direction in which the user actually moves and the movement direction detected by the wearable electronic device 301 substantially match, and identify that this is the time point for transmitting the reference information to the external wearable electronic device 401.

According to an embodiment of the disclosure, when the first processor 320 determines that the wearable electronic device 301 worn on the user's arm is vertically raised by a first threshold or more based on sensor information obtained from an acceleration sensor of the first sensor module 376, determines that a roll value and pitch value calculated based on the sensor information obtained from the acceleration sensor of the first sensor module 376 are equal to or less than a second threshold, and determines that a movement of the wearable electronic device 301 is less than a third threshold, during monitoring of the movement of the wearable electronic device 301, the first processor 320 may identify that the wearable electronic device 301 is in the first posture.

According to an embodiment of the disclosure, when identifying that the wearable electronic device 301 is in the first posture, the first processor 320 may transmit absolute azimuth information calculated based on sensor information obtained from the geomagnetic sensor and/or the acceleration sensor of the first sensor module 376 as reference information to the external wearable electronic device 401.

According to an embodiment of the disclosure, the first processor 320 may calculate the absolute azimuth information ‘(e.g., yaw) based on the sensor information obtained from the geomagnetic sensor and the acceleration sensor of the first sensor module 376 based on the following Equation 1.

$$Ψ = {tan}^{- {1}^{-}} \frac{{m}_{ν} cos ϕ + {m}_{∠} s i 11 ∅}{{m}_{x} cos θ + {m}_{y} sin ϕ sin θ + {m}_{2} cos ϕ sin θ} \qquad Equation 1$$

mₓ, m_{y} and m_{z}: sensor data obtained from the geomagnetic sensor

θ, Φ: roll and pitch values calculated based on the sensor data obtained from the acceleration sensor

Equation 1 is only an example to help understanding, which should not be construed as limiting, and may be modified, applied, or extended in various ways.

According to an embodiment of the disclosure, when the velocity of the wearable electronic device 301 is equal to or higher than a threshold velocity (e.g., about 5 km/h), the first processor 320 may identify that a time point for transmitting reference information to the external wearable electronic device 401 is reached, calculate absolute azimuth information based on a location signal obtained from the location measurement module 380, and transmit the absolute azimuth information as the reference information to the external wearable electronic device.

According to an embodiment of the disclosure, when the first processor 320 identifies that the velocity of the wearable electronic device is equal to or higher than the threshold velocity (e.g., about 5 km/h), the first processor 320 may identify that it is a confidence interval for a movement direction detected based on a location signal obtained from the location measurement module 380, and transmit absolute azimuth information calculated based on the location signal obtained from the location measurement module 380 in the confidence interval as reference information to the external wearable electronic device 401.

According to an embodiment of the disclosure, when the first processor 320 identifies a time point for calculating the absolute azimuth information as the reference information in the wearable electronic device 301, the first processor 320 may request posture information for updating the posture information about the external wearable electronic device 401 from the external wearable electronic device 401. When the first processor 320 receives the posture information (e.g., relative azimuth information) about the external wearable electronic device 401 calculated by the external wearable electronic device 401 from the external wearable electronic device 401, the first processor 320 may compare the reference information with the posture information about the external wearable electronic device 401. When the relative azimuth information, which is the posture information about the external wearable electronic device 401, does not match the absolute azimuth information, which is the reference information as a result of the comparison, the first processor 320 may update the relative azimuth information, which is the posture information about the external wearable electronic device 401, to the absolute azimuth information, which is the reference information. The first processor 320 may transmit the azimuth information, which is the updated posture information about the external wearable electronic device 401, to the external wearable electronic device 401.

According to an embodiment of the disclosure, when the first processor 320 identifies that the reception sensitivity of the location signal is equal to or less than a threshold level during detection and recording of the movement direction of the wearable electronic device 301 based on the location signal received from the location measurement module 380, the first processor 320 may request posture information about the external wearable electronic device 401 (e.g., the second wearable electronic device 401 of FIG. 2) from the external wearable electronic device, in order to detect the movement direction of the wearable electronic device by applying it to pedestrian dead reckoning.

According to an embodiment of the disclosure, when the reception sensitivity of the location signal received from the location measurement module 380 is equal to or less than the threshold level, the first processor 320 may detect the movement direction of the wearable electronic device 301 by using the SHS, which is pedestrian dead reckoning, instead of the location measurement module 380.

The SHS is a method of predicting a current location from a previous location through a movement displacement and a movement direction. The movement displacement may be detected as a walking stride of the user wearing the wearable electronic device 301, and the movement direction is detected as azimuth information calculated by applying sensor information received from the geomagnetic sensor and/or acceleration sensor of the wearable electronic device 301 to the above Equation 1. However, when the user wearing the wearable electronic device 301 on the arm moves (e.g., walking or running), the movement of the user's arm may generate a lot of rotation and pendulum movement, which is accompanied by shock, and when the amount of shock is transmitted to the wearable electronic device 301, there is no problem in detecting a step, but the accuracy of detecting azimuth information for detecting the movement direction may be reduced.

In the disclosure, when the movement direction of the wearable electronic device is detected using the SHS, the movement direction of the wearable electronic device 301 may be detected by applying azimuth information included in posture information about the external wearable electronic device (e.g., earbuds worn on the user's ears) worn on a part of the user's head to the SHS. The movement direction of the wearable electronic device 301 may be detected based on the posture information about the external wearable electronic device (e.g., earbuds worn on the user's ears) worn on a part of the user's head, relying on the characteristic that when the user moves (e.g., walking or running), the user's head posture is fixed, changes little, and substantially coincides with the user's movement direction.

According to an embodiment of the disclosure, the first processor 320 may detect the movement direction of the wearable electronic device through the SHS using the following Equation 2.

$$\begin{matrix}{X}_{t} = {X}_{t - 1} + D \cdot Cos ( Ψ ) \\ {Y}_{t} = {Y}_{t - 1} + D \cdot Sin ( Ψ ) \\ {X}_{t - 1} , {Y}_{t - 1} : Previous location\end{matrix} \qquad Equation 2$$

D: Step length

Ψ: Posture information (azimuth information) received from the external wearable electronic device

Equation 2 is only an example to help understanding, which should not be construed as limiting, and may be modified, applied, or extended in various ways.

According to an embodiment of the disclosure, the first processor 320 may detect the step length D by using a maximum detection technique, a zero-crossing detection technique, an interval detection technique, and/or an autocorrelation technique.

According to an embodiment of the disclosure, when the first processor 320 that the location signal received from the location measurement module 380 is equal to or greater than a threshold level during detection and recording of the movement direction of the wearable electronic device 301 by using the SHS, the first processor 320 may detect and record the movement direction of the wearable electronic device based on the location signal received from the location measurement module 380.

According to an embodiment of the disclosure, when display of a movement trajectory is requested, the first processor 320 may control the first display 360 to display a movement trajectory (e.g., an exercise trajectory) that records the movement direction of the wearable electronic device 301 using the location measurement module 380 and/or pedestrian dead reckoning (e.g., the SHS), while the location-based application is running.

According to an embodiment of the disclosure, the first memory 330 may be implemented substantially the same as or similar to the memory 130 of FIG. 1.

According to an embodiment of the disclosure, the movement trajectory (e.g., exercise trajectory) that records the movement direction of the wearable electronic device 301 while the location-based application is running may be stored in the first memory 330.

According to an embodiment of the disclosure, the first display 360 may be implemented substantially the same as or similar to the display module 160 of FIG. 1.

According to an embodiment of the disclosure, the first display 360 may display the movement trajectory that records the movement direction of the wearable electronic device 301 while the location-based application is running, in response to the request for display of the movement trajectory (e.g., exercise trajectory).

According to an embodiment of the disclosure, the first sensor module 376 may be implemented substantially the same as or similar to the sensor module 176 of FIG. 1.

According to an embodiment of the disclosure, the first sensor module 376 may include an acceleration sensor, a gyro sensor, and/or a geomagnetic sensor.

According to an embodiment of the disclosure, the location measurement module 380 may include a global navigation satellite system (GNSS) receiver that measures a location.

According to an embodiment of the disclosure, the first communication module 390 may be implemented substantially the same as or similar to the communication module 190 of FIG. 1, and include a plurality of communication circuits using different communication technologies.

According to an embodiment of the disclosure, the first communication module 390 may include at least one of a wireless LAN module (not shown) or a short-range communication module (not shown), and the short-range communication module (not shown) may include an ultra wide band (UWB) communication module, a Wi-Fi communication module, an NFC communication module, a Bluetooth legacy communication module, and/or a BLE communication module.

FIG. 4 is a block diagram 400 illustrating a second wearable electronic device according to an embodiment of the disclosure.

When FIG. 4 illustrates, for example, a pair of earbuds as the wearable electronic device 401 wearable on a part of a user's head, the configuration of FIG. 4 may represent the configuration of an earbud that performs a primary role in the pair of earbuds, and the configuration of an earbud that performs a secondary role in the pair of earbuds may also include substantially the same configuration as FIG. 4.

Referring to FIG. 4, according to an embodiment of the disclosure, the wearable electronic device 401 (e.g., the second wearable electronic device 401 of FIG. 2) may include a second processor 420, second memory 430, a second display 460, a second sensor module 476, and/or a second communication module 490.

At least some of the components of the wearable electronic device 401 illustrated in FIG. 4 may be identical or similar to those of the electronic device 101 of FIG. 1, and a redundant description will be avoided below.

According to an embodiment of the disclosure, the second processor 420 may be implemented substantially the same as or similar to the processor 120 of FIG. 1.

According to an embodiment of the disclosure, when the second processor 420 receives a request for calculating posture information about the wearable electronic device 401 from an external wearable electronic device (e.g., the first wearable electronic device 301 of FIG. 2), the second processor 420 may calculate the posture information about the wearable electronic device based on the second sensor module 476.

According to an embodiment of the disclosure, the second processor 420 may receive the request for calculating posture information about the wearable electronic device 401 from the external wearable electronic device 301, after transmitting information indicating that the wearable electronic device 401 is worn on a part of the user's head to the external wearable electronic device 301 through the second communication module 490.

According to an embodiment of the disclosure, the second processor 420 may detect relative azimuth information calculated based on sensor information obtained from an acceleration sensor and/or a gyro sensor of the second sensor module 476 as the posture information.

According to an embodiment of the disclosure, when the second processor 420 receives reference information for updating the posture information about the wearable electronic device 401 from the external wearable electronic device (e.g., the first wearable electronic device 301 of FIG. 2), the second processor 420 may compare the reference information with the posture information about the wearable electronic device 401, and when the relative azimuth information, which is the posture information about the wearable electronic device 401, does not match absolute azimuth information, which is the reference information as a result of the comparison, the second processor 420 may update the relative azimuth information, which is the posture information about the wearable electronic device 401, to the absolute azimuth information, which is the reference information.

According to an embodiment of the disclosure, when the second processor 420 receives a request for posture information for updating the posture information about the wearable electronic device 401 from the external wearable electronic device 301, the second processor 420 may calculate posture information (e.g., relative azimuth information) about the wearable electronic device 401 based on the second sensor module 476 and transmit the calculated posture information to the external wearable electronic device 301. The second processor 420 may receive, from the external wearable electronic device 301, azimuth information to which the posture information (e.g., relative azimuth information) about the wearable electronic device 401 has been updated based on the reference information (e.g., absolute azimuth information) of the external wearable electronic device 301, and store the azimuth information. After receiving the request for posture information for updating the posture information about the wearable electronic device 401 from the external wearable electronic device 301, the second processor 420 may transmit the posture information about the wearable electronic device 401 to the external wearable electronic device 301, periodically or when detecting a change value of the posture of the wearable electronic device 401 equal to or greater than a threshold, and receive and store the azimuth information to which the posture information (e.g., relative azimuth information) about the wearable electronic device 401 has been updated from the external wearable electronic device 301.

According to an embodiment of the disclosure, when the second processor 420 receives the request for posture information about the wearable electronic device 401 from the external wearable electronic device (e.g., the first wearable electronic device 301 of FIG. 2), the second processor 420 may transmit the posture information about the wearable electronic device 401 to the external wearable electronic device 301 through the second communication module 490.

According to an embodiment of the disclosure, the second processor 420 may transmit relative azimuth information calculated based on sensor information obtained from the acceleration sensor and/or gyro sensor of the second sensor modules 476 of the wearable electronic device 401, azimuth information updated based on reference information received from the wearable electronic device 401, or azimuth information received from the external wearable electronic device 301 and stored, as posture information about the wearable electronic device 401, to the external wearable electronic device 301.

According to an embodiment of the disclosure, the second memory 430 may be implemented substantially the same as or similar to the memory 130 of FIG. 1.

According to an embodiment of the disclosure, the posture information about the wearable electronic device may be stored in the second memory 430.

According to an embodiment of the disclosure, the second display 460 may be implemented substantially the same as or similar to the display module 160 of FIG. 1. The second display 460 may not be included as a component, depending on the type of the wearable electronic device worn on a part of the user's head.

According to an embodiment of the disclosure, the second sensor module 476 may be implemented substantially the same as or similar to the sensor module 176 of FIG. 1.

According to an embodiment of the disclosure, the second sensor module 476 may include an acceleration sensor and/or a gyro sensor.

According to an embodiment of the disclosure, the second communication module 490 may be implemented substantially the same as or similar to the communication module 190 of FIG. 1, and include a plurality of communication circuits using different communication technologies.

According to an embodiment of the disclosure, the second communication module 490 may include at least one of a wireless LAN module (not shown) or a short-range communication module (not shown), and the short-range communication module (not shown) may include a UWB communication module, a Wi-Fi communication module, an NFC communication module, a Bluetooth legacy communication module, and/or a BLE communication module.

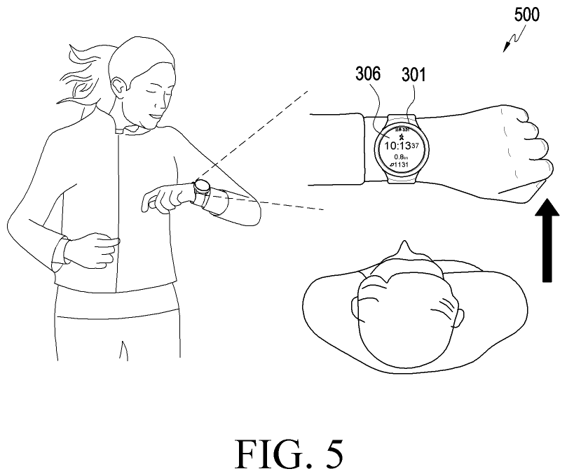

FIG. 5 is a diagram 500 illustrating a time point for transmitting reference information in a wearable electronic device according to an embodiment of the disclosure.

Referring to FIG. 5, when the wearable electronic device 301 (e.g., the first wearable electronic device 301 of FIG. 2 and the wearable electronic device 301 of FIG. 3) detects the first posture of the wearable electronic device 301 in which the user lifts the arm wearing the wearable electronic device 301 and gazes at the display 360 (e.g., the display 360 of FIG. 3) of the wearable electronic device 301 in the state where the wearable electronic device is decreased in velocity or stationary, the wearable electronic device 301 may identify that this is a time point when an actual movement direction of the user and a movement direction detected by the wearable electronic device 301 substantially match.

When the wearable electronic device 301 determines that the wearable electronic device 301 worn on the user's arm is vertically raised by the first threshold or more based on sensor information obtained from the sensor module (the first sensor module 376 of FIG. 3) of the wearable electronic device 301, determines that a roll value and pitch value calculated based on sensor information obtained from the acceleration sensor of the first sensor module 376 are equal to or less than the second threshold, and determines a the movement of the wearable electronic device 301 is less than the third threshold, during monitoring of the movement of the wearable electronic device 301, the wearable electronic device 301 may identify that it is in the first posture.

When the wearable electronic device 301 detects the first posture of the wearable electronic device 301, the wearable electronic device 301 may identify that a time point is reached for transmitting reference information to the external wearable electronic device (e.g., the second wearable electronic device 401 of FIG. 2 and/or the wearable electronic device 401 of FIG. 4).

The wearable electronic device 301 may transmit, to the external wearable electronic device 401, absolute azimuth information calculated by applying sensor information obtained from the geomagnetic sensor and acceleration sensor of the sensor module to Equation 1 as the reference information for updating the posture information about the external wearable electronic device 401.

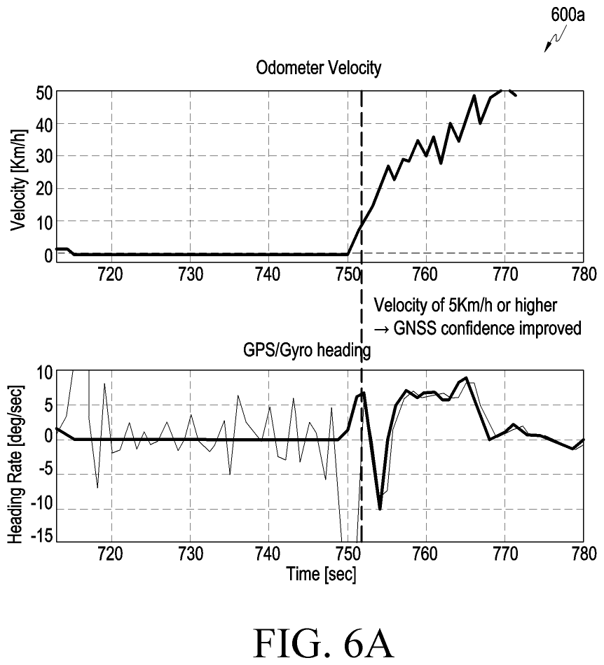

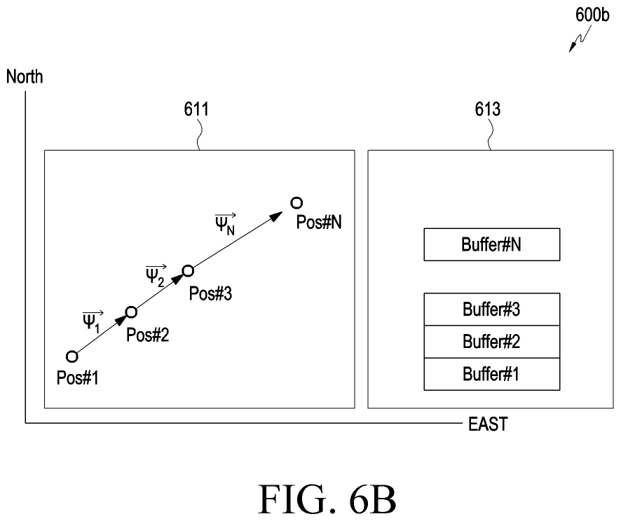

FIGS. 6A and 6B are diagrams 600a and 600b illustrating a time point for transmitting reference information transmission in a wearable electronic device according to various embodiments of the disclosure.

Location information has a location error depending on measuring means. When a movement velocity does not exceed an error range, a movement direction may be calculated completely differently. However, when the movement velocity is great, the movement may be outside the location error. Therefore, although there may be a slight difference in direction, the overall movement direction is correct, and thus the error in the movement direction is relatively reduced. Therefore, when the wearable electronic device (e.g., the first wearable electronic device 301 of FIG. 2 and/or the wearable electronic device 301 of FIG. 3) has a movement velocity equal to or higher than a threshold velocity, a movement direction measured based on a location signal obtained from the location measurement module (e.g., the location measurement module 380 of FIG. 3) of the wearable electronic device may be more accurate.

FIG. 6A illustrates test results of measuring azimuth information calculated based on a location signal received from a GNSS receiver, which is a location measurement module. In 6A, the x axis represents time8 sec], and the y axis represents velocity. As noted from the test results, when the movement velocity of the wearable electronic device including the GNSS receiver is equal to or higher than a threshold velocity (e.g., about 5 km/h), it may be identified as a confidence interval for a location signal received through the GNSS receiver. Accordingly, the wearable electronic device (e.g., the first wearable electronic device 301 of FIG. 2 and/or the wearable electronic device 301 of FIG. 3) may transmit, to the wearable electronic device 401, absolute azimuth information calculated in the confidence interval as reference information for updating posture information about the external wearable electronic device (e.g., the second wearable electronic device 401 of FIG. 2 and/or the wearable electronic device 401 of FIG. 4).

Referring to FIG. 6B, the wearable electronic device (e.g., the first wearable electronic device 301 of FIG. 2 and/or the wearable electronic device 301 of FIG. 3) may calculate a vector of a movement direction of the wearable electronic device 301 based on a location signal received from the GNSS receiver, and derive a movement direction value (heading value) of the wearable electronic device 301 in east north up (ENU) coordinates from the calculated vector information. The ENU coordinates are one of GNSS coordinate systems that represent a map as a coordinate system in which the x axis represents the east, the y axis represents the north, and the z axis represents the vertical direction. Pos #1, Pos #2, Pos #3, . . . , Pos #N displayed in ENU coordinates represent movement locations detected on the x axis, y axis, and z axis, and Ψ₁, Ψ₂, . . . , Ψ_{N} represent magnetic north that may be predicted by a ratio of measurements on the x axis and y axis according to a movement location. The wearable electronic device may store heading information, which is angle information from the north to the east calculated from a coordinate vector, in a buffer as history data, and then determine a movement state (straight state) of the wearable electronic device 301 by using data statistical values, such as a variance and a standard deviation.

The wearable electronic device 301 may update the coordinates of a movement location through the logic of (1) operation 611 in which a movement direction value (heading value) of the wearable electronic device 301 is calculated in ENU coordinates, and (2) operation 613 in which the movement state (straight state) of the wearable electronic device 301 may be determined by using data statistical values, such as a variance and a standard deviation after heading information, which is angle information from the north to the east calculated from a coordinate vector, is stored as history data in a buffer, and when determining that the movement state of the user wearing the wearable electronic device is straight, transmit, to the external wearable electronic device 401, absolute azimuth information calculated from a location vector as reference information for updating posture information about the external wearable electronic device (e.g., the second wearable electronic device 401 of FIG. 2 and/or the wearable electronic device 401 of FIG. 4).

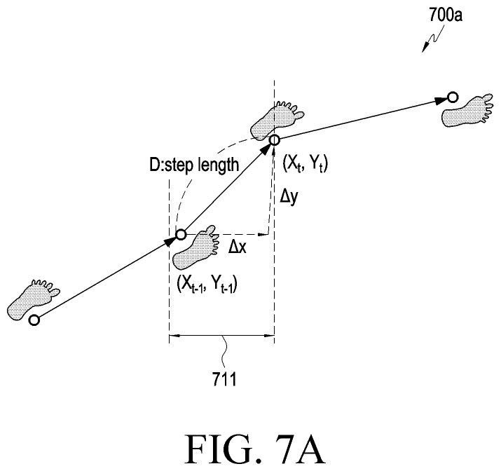

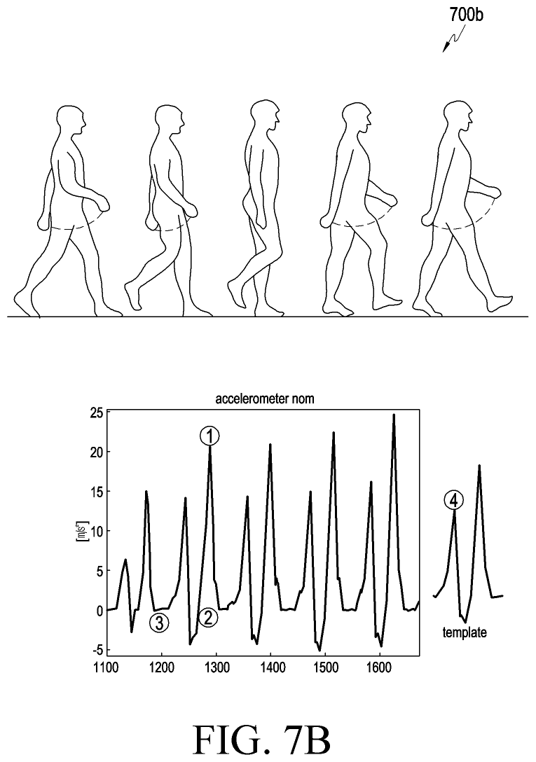

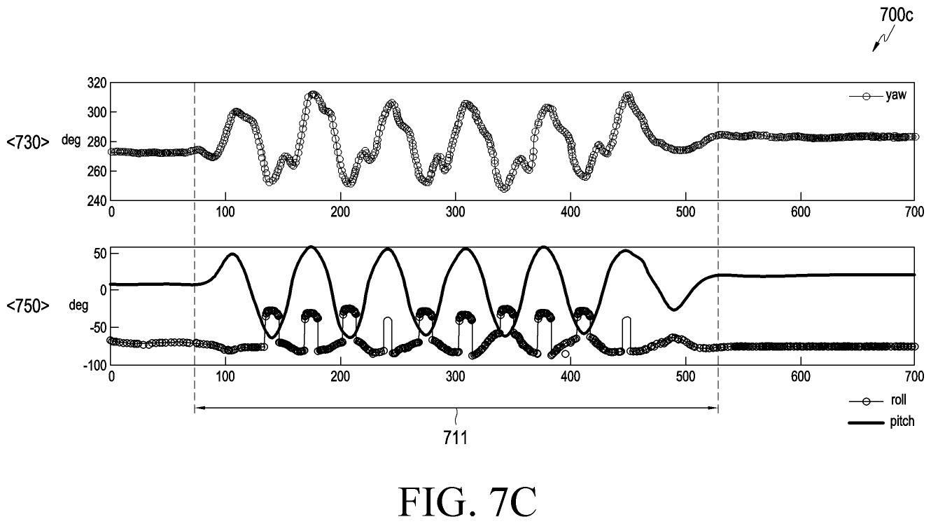

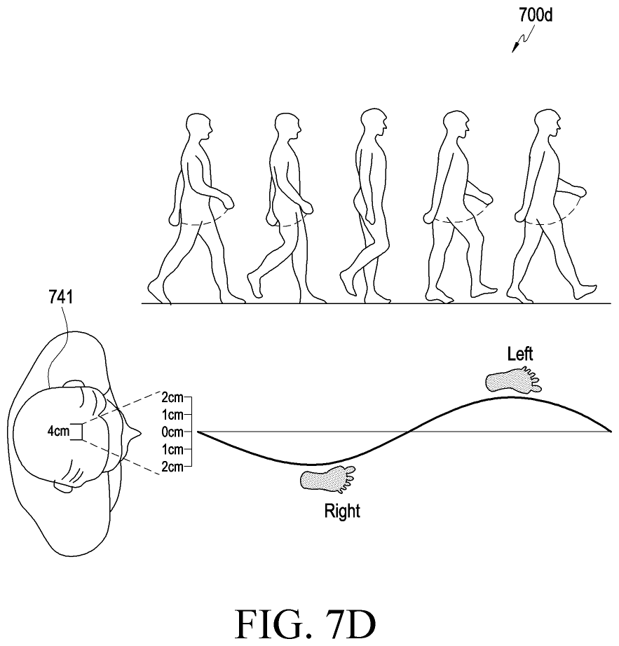

FIGS. 7A, 7B, 7C, and 7D are diagrams 700a, 700b, 700c, and 700d illustrating an operation of detecting a movement direction using the SHS in a wearable electronic device according to various embodiments of the disclosure.

Referring to FIG. 7A, the wearable electronic device (e.g., the first wearable electronic device 301 of FIG. 2 and/or the wearable electronic device 301 of FIG. 3) may detect a movement direction of the wearable electronic device worn on an arm of a user's body, using the SHS in a section 711 where the reception sensitivity of a location signal received from the location measurement module (e.g., the location measurement module 380 of FIG. 3) is equal to or less than the threshold level. The SHS may detect the movement direction of the wearable electronic device 301 by using a movement displacement Δx and Δy and a step length D from a previous location Xₜ₋₁ and Yₜ₋₁ to a current location Xₜ and Yₜ.

In the SHS, the current location may be predicted by applying the movement displacement (step length) and the movement direction (azimuth information) from the previous location to the above-mentioned Equation 2, and thus a method of accurately predicting the movement displacement and the movement direction from the sensor may be required for more accurate location update.

Referring to FIG. 7B, a motion including a movement of a user's arm wearing the wearable electronic device (e.g., the first wearable electronic device 301 of FIG. 2 and/or the wearable electronic device 301 of FIG. 3) may involve a lot of rotation and pendulum movement, and may be accompanied by shock. Although the amount of shock transmitted to the wearable electronic device 301 has a distinct pattern according to the user's arm movement, there is no problem in detecting the user's steps. The detection of the steps is possible through \textcircled{1} a maximum detection technique, \textcircled{2} a zero-crossing detection technique, \textcircled{3} an interval detection technique, and \textcircled{4} an autocorrelation technique. The maximum detection technique detects a step by using a maximum impact point of the step, and the zero-crossing detection technique detects a step as a point where the pattern of an acceleration shock crosses a value of 0 on the x axis. The interval detection technique is a method of determining a step when the magnitude of a shock is equal to or larger than a certain magnitude, and the autocorrelation technique is a step detection method based on step pattern matching.

Referring to FIG. 7C, when azimuth information is calculated by applying sensor information obtained through the geomagnetic sensor included in the wearable electronic device 301 to the above-mentioned Equation 1 in the section 711 where a motion occurs in which the arm of a user wearing the wearable electronic device (e.g., the first wearable electronic device 301 of FIG. 2 and/or the wearable electronic device 301 of FIG. 3) moves, the accuracy of the azimuth information Ψ (e.g., yaw) calculated by Equation 1 decreases as illustrated in a graph <730>, as the roll value and pitch value change as illustrated in a graph <750>.

Referring to FIG. 7D, a wearable electronic device that may be worn on a part of the head of the user's body (e.g., the second wearable electronic device 401 of FIG. 2 and/or the wearable electronic device 401), for example, an earbud that may be worn on the user's ear may characteristically have a relatively small variation and substantially matches the user's movement direction (forward direction), because it is at least partially fixed to the user's ear during the user's walking or running.

When a user 741 walks while looking straight ahead (e.g., 0 cm) to view a location to which the user 741 wants to move, the head of the user 741 may move about 2 cm to the left and about 2 cm to the right relative to the straight ahead (e.g., 0 cm). Since the movement variation of the head of the user 741 is approximately 4 cm relative to the straight ahead (e.g., 0 cm), posture information (e.g., azimuth information) about the wearable electronic device 401 worn on a part of the user's head may be used as azimuth information about an external wearable electronic device (e.g., the first wearable electronic device 301 of FIG. 2 and/or the wearable electronic device 301 of FIG. 3) communication-connected to the wearable electronic device 401.

For example, when an earbud at least partially worn on the user's ear receives a request for calculating posture information about the earbud from a smart watch communication-connected to the earbud, the posture information (e.g., azimuth information) about the earbud may be calculated based on sensor information obtained through a sensor module of the earbud. When the earbud receives reference information for updating the posture information about the earbud from the smart watch, the posture information (e.g., relative azimuth information) may be updated based on the reference information (absolute azimuth information), and when the earbud receives a request for posture information about the earbud from the smart watch to detect the movement direction of the smart watch, the earbud may transmit the updated posture information about the earbud to the smart watch.

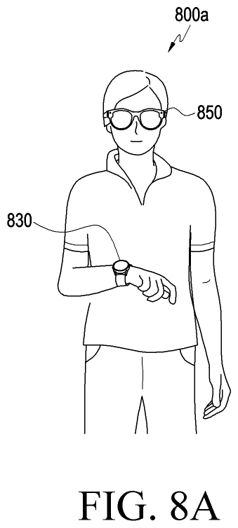

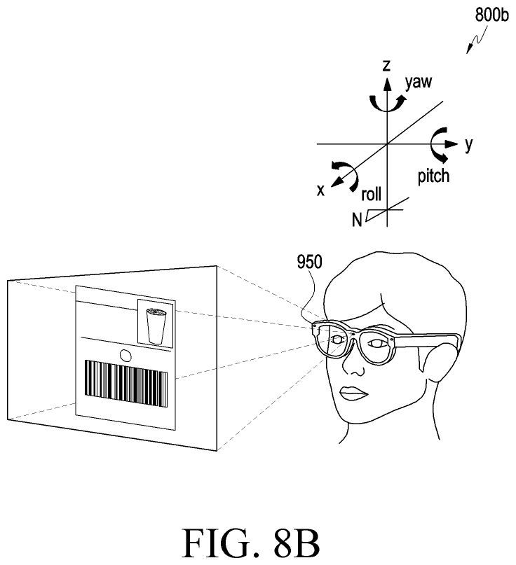

FIGS. 8A and 8B are diagrams 800a and 800b illustrating an operation of providing various functions using a wearable electronic device according to various embodiments of the disclosure.

Referring to FIG. 8A, while a wearable electronic device that may be worn on an arm of a user's body (e.g., the first wearable electronic device 301 of FIG. 2 and/or the wearable electronic device 301 of FIG. 3), for example, a smart watch 830, is being connected to a wearable electronic device that may be worn on the head of the user's body (e.g., the second wearable electronic device 401 of FIG. 2 and/or the wearable electronic device 401 of FIG. 4), for example, smart glasses 850, a current location may be identified using location information obtained through a GNSS receiver included in the smart watch 830, and information about a movement and/or direction of the user's head may be identified based on sensor information obtained through a sensor module included in the smart glasses 850. The information about the movement and/or direction of the user's head may be identified more accurately using leg parts of the smart glasses, which are at least partially fixed to the user's ears. While the smart watch 830 and the smart glasses 850 are sharing the current location information identified by the smart watch 830 and the information about the movement and/or direction of the user's head identified by the smart glasses 850 with each other, the smart watch 830 or the smart glasses 850 may provide the user with guide information based on the user's current location or the information about the movement and/or direction of the user's head. For example, when the user looks at the sky, the weather may be provided, when the user arrives at a famous tourist destination, historical events or explanations of the tourist destination may be output as audio, or at the airport, the departure gate may be notified.

Referring to FIG. 8B, a wearable electronic device that may be worn on a part of the head of a user's body (e.g., the second wearable electronic device 401 of FIG. 2 and/or the wearable electronic device 401 of FIG. 4), for example, smart glasses 950 may detect a movement of the smart glasses by measuring a gravitational acceleration of x, y, and z through an acceleration sensor included in the smart glasses, and detect rotation about the x, y, and z axes through a gyro sensor included in the smart glasses 950. The smart glasses 950 may detect a motion of a user turning his/her head or lowering it up or down. When absolute azimuth information calculated based on sensor information obtained from a geomagnetic sensor included in the smart glasses 950 is used, the motion of the user turning his/her head or lowering it up or down may be detected more accurately. When the accuracy of the geomagnetic sensor is reduced due to surrounding electronic devices, the smart glasses 950 may correct sensor misalignment caused by external influences by referring to sensor information obtained from the geomagnetic sensor and sensor information obtained from the gyro sensor.

A wearable electronic device (101 of FIG. 1, 301 of FIG. 2, or 301 of FIG. 3) according to an embodiment may include a sensor module (176 of FIG. 1 or 376 of FIG. 3), a location measurement module (380 of FIG. 3), a communication module (190 of FIG. 1 or 390 of FIG. 3), and a processor (120 of FIG. 1 or 320 of FIG. 3).

When identifying execution of a location-based application, the processor (120 of FIG. 1 or 320 of FIG. 3) according to an embodiment may request an external wearable electronic device (401 of FIG. 2 and 401 of FIG. 4) communication-connected through the communication module to calculate posture information about the external wearable electronic device.

When identifying that a reception sensitivity of a location signal received from the location measurement module is equal to or less than a threshold level during detection of a movement direction of the wearable electronic device (101 of FIG. 1, 301 of FIG. 2, or 301 of FIG. 3) based on the location signal, the processor (120 of FIG. 1 or 320 of FIG. 3) according to an embodiment may request the posture information about the external wearable electronic device from the external wearable electronic device.

The processor (120 of FIG. 1 or 320 of FIG. 3) according to an embodiment may detect the movement direction of the wearable electronic device by applying the posture information received from the external wearable electronic device to pedestrian dead reckoning.

The processor (120 of FIG. 1 or 320 of FIG. 3) according to an embodiment may connect communication to the external wearable electronic device worn on a part of a user's head through the communication module, while the wearable electronic device is worn on the user's arm.

The processor (120 of FIG. 1 or 320 of FIG. 3) according to an embodiment may transmit, to the external wearable electronic device, reference information calculated based on sensor information obtained from the sensor module or the location signal obtained from the location measurement module, when identifying that a time point is reached for transmitting the reference information for updating the posture information calculated by the external wearable electronic device during the detection of the movement direction of the wearable electronic device based on the location signal received from the location measurement module.

When determining that the wearable electronic device is vertically raised by a first threshold or more based on the sensor module, determining that a roll value and a pitch value are equal to or less than a second threshold, and determining that a movement of the wearable electronic device is less than a third threshold, the processor (120 of FIG. 1 or 320 of FIG. 3) according to an embodiment may identify that the wearable electronic device is in a first posture, and identify that the time point for transmitting the reference information is reached, when identifying the first posture.

When identifying that the time point for transmitting the reference information is reached, the processor (120 of FIG. 1 or 320 of FIG. 3) according to an embodiment may transmit the reference information calculated based on a sensor signal obtained from the sensor module to the external wearable electronic device.

The processor (120 of FIG. 1 or 320 of FIG. 3) according to an embodiment may identify that the time point for transmitting the reference information is reached, when detecting that a velocity of the wearable electronic device is equal to or higher than a threshold velocity based on the location measurement module, and transmit the reference information calculated based on the location signal obtained from the location measurement module to the external wearable electronic device, when identifying that the time point for transmitting the reference information is reached.

The processor (120 of FIG. 1 or 320 of FIG. 3) according to an embodiment may calculate absolute azimuth information based on the sensor signal obtained from the sensor module or the location signal obtained from the location measurement module, and transmit the absolute azimuth information as the reference information to the external wearable electronic device.

A system for detecting a movement direction according to an embodiment may include a first wearable electronic device (e.g., 301 of FIG. 2 and 301 of FIG. 3) which, when identifying execution of a location-based application, requests a communication-connected second wearable electronic device (e.g., 401 of FIG. 2 and 401 of FIG. 4) to calculate posture information about the second wearable electronic device, when identifying that a reception sensitivity of a location signal received from a location measurement module (e.g., 380 of FIG. 3) of the first wearable electronic device is equal to or less than a threshold during detection of a movement direction of the first wearable electronic device based on the location signal, requests the posture information about the second wearable electronic device from the second wearable electronic device, and detects the movement direction of the first wearable electronic device by applying the posture information received from the second wearable electronic device to pedestrian dead reckoning.

The system according to an embodiment may include the second wearable electronic device (e.g., 401 of FIG. 2 and 401 of FIG. 4) which when receiving the request for calculating the posture information about the second wearable electronic device from the communication-connected first wearable electronic device (e.g., 301 of FIG. 2 and 301 of FIG. 3), calculates the posture information about the second wearable electronic device based on a sensor module (e.g., 476 of FIG. 4) of the second wearable electronic device, and when receiving the request for the posture information about the second wearable electronic device from the first wearable electronic device, transmits the posture information about the second wearable electronic device to the first wearable electronic device.

In the system according to an embodiment of the disclosure, when identifying that a time point is reached for transmitting reference information for updating the posture information about the second wearable electronic device (401 of FIG. 2 and 401 of FIG. 4) during detection of the movement direction of the first wearable electronic device based on the location signal from the location measurement module (380 of FIG. 3), the first wearable electronic device may transmit, to the second wearable electronic device, the reference information calculated based on a sensor signal obtained from a sensor module (e.g., 376 of FIG. 3) of the first wearable electronic device or the location signal obtained from the location measurement module.

In the system according to an embodiment of the disclosure, when receiving the reference information from the first wearable electronic device (301 of FIG. 2 and 301 of FIG. 3), the second wearable electronic device (401 of FIG. 2; 401 of FIG. 4) may update the posture information calculated by the second wearable electronic device.

In the system according to an embodiment of the disclosure, the reference information received by the second wearable electronic device (401 of FIG. 2 and 401 of FIG. 4) may include absolute azimuth information, and the posture information calculated by the second wearable electronic device may include relative azimuth information.

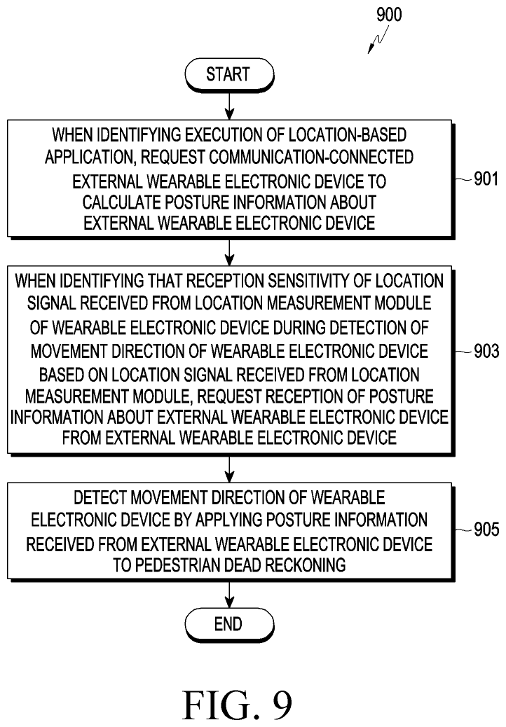

FIG. 9 is a flowchart 900 illustrating an operation of detecting a movement direction in a wearable electronic device according to an embodiment of the disclosure. The operation of detecting a movement direction may include operations 901 to 905. In the following embodiment of the disclosure, each operation may be performed sequentially, but is not necessarily performed sequentially. For example, the order of the operations may be changed, at least two operations may be performed in parallel, or another operation may be added.

According to an embodiment of the disclosure, operations 901 to 905 may be understood as performed in a processor (e.g., the processor 120 of FIG. 1 and/or the first processor 320 of FIG. 3) of a wearable electronic device (e.g., the electronic device 101 of FIG. 1, the first wearable electronic device 301 of FIG. 2, and/or the wearable electronic device 301 of FIG. 3).

According to an embodiment of the disclosure, in operation 901, when identifying execution of a location-based application, the wearable electronic device (e.g., the electronic device 101 of FIG. 1, the first wearable electronic device 301 of FIG. 2, and/or the wearable electronic device 301 of FIG. 3) may request a communication-connected external wearable electronic device to calculate posture information about the external wearable electronic device.

According to an embodiment of the disclosure, when identifying execution of the location-based application, the wearable electronic device may request the external wearable electronic device (e.g., the second wearable electronic device 401 of FIG. 2 and/or the wearable electronic device of FIG. 4) to which communication is connected through the wearable electronic device (e.g., the first communication module 390 of FIG. 3) to calculate the posture information about the external wearable electronic device, and detect and record a movement direction of the wearable electronic device based on a location signal received from a location measurement module (e.g., the location measurement module 380 of FIG. 3) of the wearable electronic device.

According to an embodiment of the disclosure, when identifying execution of a location-based application (e.g., an exercise application) requiring a movement trajectory, the wearable electronic device may identify whether it is communication-connected to the external wearable electronic device, and when it is communication-connected to the external wearable electronic device, request the external wearable electronic device to calculate posture information about the external wearable electronic device through the communication module.

According to an embodiment of the disclosure, when the wearable electronic device identifies that the wearable electronic device is worn on an arm of a user's body and receives, from the external wearable electronic device, status information indicating that the external wearable electronic device is worn on the head of the user's body, while being connected to the external wearable electronic device, the wearable electronic device may request the external wearable electronic device to calculate posture information about the external wearable electronic device through the communication module.

According to an embodiment of the disclosure, in operation 903, when the wearable electronic device (e.g., the electronic device 101 of FIG. 1, the first wearable electronic device 301 of FIG. 2, and/or the wearable electronic device 301 of FIG. 3) identifies that the reception sensitivity of a location signal received from the location measurement module of the wearable electronic device is equal to or less than a threshold level, during detection of a movement direction of the wearable electronic device based on the location signal received from the location measurement module, it may request the posture information about the external wearable electronic device from the external wearable electronic device (e.g., the second wearable electronic device 401 of FIG. 2 and/or the wearable electronic device 401 of FIG. 4).

According to an embodiment of the disclosure, in operation 905, the wearable electronic device (e.g., the electronic device 101 of FIG. 1, the first wearable electronic device 301 of FIG. 2, and/or the wearable electronic device 301 of FIG. 3) may detect the movement direction of the wearable electronic device by applying the posture information received from the external wearable electronic device (e.g., the second wearable electronic device 401 of FIG. 2, and/or the wearable electronic device 401 of FIG. 4) to pedestrian dead reckoning.

According to an embodiment of the disclosure, when the reception sensitivity of the location signal received from the location measurement module (e.g., the location measurement module 380 of FIG. 3) of the wearable electronic device is equal to or less than the threshold level, the wearable electronic device may detect its movement direction by using the SHS, which is pedestrian dead reckoning.

According to an embodiment of the disclosure, the wearable electronic device may detect the movement direction of the wearable electronic device by applying the posture information (e.g., azimuth information) received from the external wearable electronic device to Equation 2, in order to detect the movement direction of the wearable electronic device, using the SHS, which is pedestrian dead reckoning.

According to an embodiment of the disclosure, when identifying that the location signal received from the location measurement module (e.g., the location measurement module 380 of FIG. 3) of the wearable electronic device is equal to or less than the threshold level during the detection and recording of the movement direction of the wearable electronic device using the SHS, the wearable electronic device may detect and record the movement direction of the wearable electronic device based on the location signal received from the location measurement module.

According to an embodiment of the disclosure, when display of the movement trajectory is requested, the wearable electronic device may control a display (e.g., the first display 360 of FIG. 3) to display the movement trajectory (e.g., an exercise trajectory) for which the movement direction of the wearable electronic device is recorded using the location measurement module and/or the SHS during the execution of the location-based application.

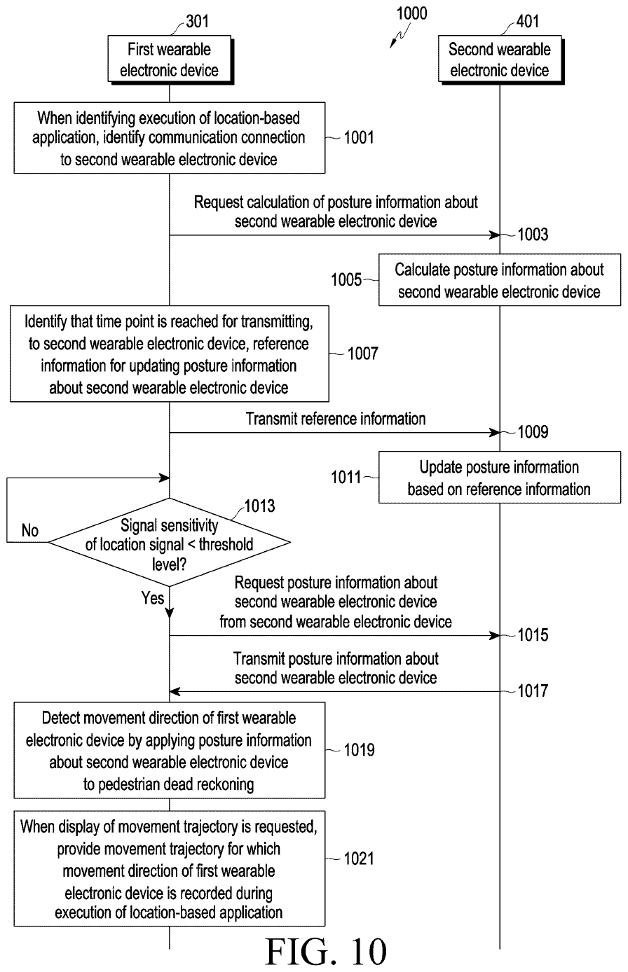

FIG. 10 is a flowchart 1000 illustrating an operation of detecting a movement direction in a wearable electronic device according to an embodiment of the disclosure. The operation of detecting a movement direction may include operations 1001 to 1021. In the following embodiment of the disclosure, each operation may be performed sequentially, but is not necessarily performed sequentially. For example, the order of the operations may be changed, at least two operations may be performed in parallel, or another operation may be added.

According to an embodiment of the disclosure, operations 1001 to 1021 may be understood as being performed by a processor (e.g., the processor 120 of FIG. 1 and/or the first processor 320 of FIG. 3) of a first wearable electronic device (e.g., the electronic device 101 of FIG. 1, the first wearable electronic device 301 of FIG. 2, and/or the wearable electronic device 301 of FIG. 3) or a processor (e.g., the processor 120 of FIG. 1 and/or the second processor 420 of FIG. 4) of a second wearable electronic device (e.g., the electronic device 101 of FIG. 1, the second wearable electronic device 401 of FIG. 2, and/or the wearable electronic device 401 of FIG. 4).

According to an embodiment of the disclosure, in operation 1001, when identifying execution of a location-based application, the first wearable electronic device 301 (e.g., the electronic device 101 of FIG. 1, the first wearable electronic device 301 of FIG. 2, and/or the wearable electronic device 301 of FIG. 3) may identify a communication connection to the second wearable electronic device 401 (e.g., the electronic device 101 of FIG. 1, the second wearable electronic device 401 of FIG. 2, and/or the second wearable electronic device 401 of FIG. 4).

According to an embodiment of the disclosure, when identifying execution of a location-based application (e.g., an exercise application) requiring a movement trajectory, the first wearable electronic device 301 may identify whether it is communication-connected to the second wearable electronic device 401.

According to an embodiment of the disclosure, while being communication-connected to the second wearable electronic device 401, the first wearable electronic device 301 may identify that the first wearable electronic device 301 is worn on an arm of a user's body and receive, from the second wearable electronic device 401, status information indicating that the second wearable electronic device 401 is worn on the head of the user's body.

According to an embodiment of the disclosure, in operation 1003, the first wearable electronic device 301 (e.g., the electronic device 101 of FIG. 1, the first wearable electronic device 301 of FIG. 2, and/or the wearable electronic device 301 of FIG. 3) may request the second wearable electronic device 401 (e.g., the electronic device 101 of FIG. 1, the second wearable electronic device 401 of FIG. 2, and/or the second wearable electronic device 401 of FIG. 4) to calculate posture information about the second wearable electronic device.

According to an embodiment of the disclosure, in operation 1005, the second wearable electronic device 401 (e.g., the electronic device 101 of FIG. 1, the second wearable electronic device 401 of FIG. 2, and/or the second wearable electronic device 401 of FIG. 4) may calculate the posture information about the second wearable electronic device.

According to an embodiment of the disclosure, when the second wearable electronic device 401 receives the request for calculating the posture information about the second wearable electronic device 401 from the first wearable electronic device 301, the second wearable electronic device 401 may calculate the posture information about the wearable electronic device based on the second wearable electronic device (e.g., the second sensor module 476 of FIG. 4).

According to an embodiment of the disclosure, after the second wearable electronic device 401 transmits the information indicating that the second wearable electronic device 401 is worn on a part of the user's head to the first wearable electronic device 301 through the communication module (e.g., the second communication module 490 of FIG. 4), it may receive the request for calculating the posture information about the second wearable electronic device 401 from the first wearable electronic device 301.

According to an embodiment of the disclosure, the second wearable electronic device 401 may detect, as the posture information, relative azimuth information calculated based on sensor information obtained from the acceleration sensor and/or gyro sensor in the sensor module (e.g., the second sensor module 476 of FIG. 4) of the second wearable electronic device.

According to an embodiment of the disclosure, in operation 1007, the first wearable electronic device 301 (e.g., the electronic device 101 of FIG. 1, the first wearable electronic device 301 of FIG. 2, and/or the wearable electronic device 301 of FIG. 3) may identify that a time point is reached for transmitting reference information for updating the posture information about the second wearable electronic device 401 (e.g., the electronic device 101 of FIG. 1, the second wearable electronic device 401 of FIG. 2, and/or the second wearable electronic device 401 of FIG. 4).

According to an embodiment of the disclosure, when the first wearable electronic device 301 detects a first posture of the first wearable electronic device 301 in which the user raises the arm wearing the first wearable electronic device 301 and gazes at the display (e.g., the first display 360 of FIG. 3 of the first wearable electronic device 301) in the state where the first wearable electronic device 301 decreases in velocity or is stationary, the first wearable electronic device 301 may identify that a time point when an actual movement direction of the user and the movement direction detected by the first wearable electronic device 301 substantially match has occurred, and identify that this is the time point for transmitting the reference information to the second wearable electronic device 401.

According to an embodiment of the disclosure, when the first wearable electronic device 301 determines that the first wearable electronic device 301 worn on the user's arm is vertically raised by a first threshold or more based on sensor information obtained from the sensor module (the first sensor module 376 of FIG. 3) of the first wearable electronic device 301, determines that a roll value and pitch value calculated based on sensor information obtained from the acceleration sensor of the sensor module are equal to or less than a second threshold, and determines that a movement of the first wearable electronic device 301 is less than a third threshold, during monitoring of the movement of the first wearable electronic device 301, the first wearable electronic device 301 may identify that it is in the first posture.

According to an embodiment of the disclosure, when the velocity of the first wearable electronic device is equal to or higher than a threshold velocity (e.g., about 5 km/h), the first wearable electronic device 301 may identify that it is a confidence interval for a movement direction detected based on a location signal obtained from the location measurement module (e.g., the location measurement module 380) of the first wearable electronic device, and identify that a time point for transmitting the reference information to the second wearable electronic device 401 is reached.

According to an embodiment of the disclosure, in operation 1009, the first wearable electronic device 301 (e.g., the electronic device 101 of FIG. 1, the first wearable electronic device 301 of FIG. 2, and/or the wearable electronic device 301 of FIG. 3) may transmit the reference information to the second wearable electronic device 401 (e.g., the electronic device 101 of FIG. 1, the second wearable electronic device 401 of FIG. 2, and/or the second wearable electronic device 401 of FIG. 4).

According to an embodiment of the disclosure, the first wearable electronic device 301 may transmit the reference information calculated based on the sensor information obtained from the sensor module (e.g., the first sensor module 376 of the first wearable electronic device) or the location signal obtained from the location measurement module (e.g., the location measurement module 380 of FIG. 3) of the first wearable electronic device to the second wearable electronic device 401.

According to an embodiment of the disclosure, when identifying that the first wearable electronic device 301 is in the first posture, the first wearable electronic device 301 may transmit absolute azimuth information calculated based on sensor information obtained from the geomagnetic sensor and/or the acceleration sensor of the sensor module (e.g., the first sensor module 376) of the first wearable electronic device as the reference information to the second wearable electronic device 401.

According to an embodiment of the disclosure, when identifying that the velocity of the first wearable electronic device 301 is equal to or higher than the threshold velocity (e.g., about 5 km/h), the first wearable electronic device 301 may calculate absolute azimuth information based on the location signal obtained from the location measurement module (e.g., the location measurement module 380 of FIG. 3) of the first wearable electronic device 301 and transmit the absolute azimuth information as the reference information to the second wearable electronic device.

According to an embodiment of the disclosure, in operation 1011, the second wearable electronic device 401 (e.g., the electronic device 101 of FIG. 1, the second wearable electronic device 401 of FIG. 2, and/or the second wearable electronic device 401 of FIG. 4) may update the posture information based on the reference information.

According to an embodiment of the disclosure, when the second wearable electronic device 401 receives the reference information for updating the posture information of the second wearable electronic device from the first wearable electronic device 301, the second wearable electronic device 401 may compare the reference information with the posture information about the wearable electronic device, and when the relative azimuth information, which is the posture information about the second wearable electronic device, does not match the absolute azimuth information, which is the reference information, as a result of the comparison, update the relative azimuth information, which is the posture information of the second wearable electronic device, to the absolute azimuth information, which is the reference information.

According to an embodiment of the disclosure, in operation 1013, the first wearable electronic device 301 (e.g., the electronic device 101 of FIG. 1, the first wearable electronic device 301 of FIG. 2, and/or the wearable electronic device 301 of FIG. 3) may compare the signal sensitivity of the location signal with a threshold level.

When identifying that the signal sensitivity of the location signal is equal to or greater than the threshold level in operation 1013 (operation 1013-No), the first wearable electronic device 301 may detect (not shown) the movement direction of the first wearable electronic device 301 based on the location signal received from the location measurement module (e.g., the location measurement module 380 of FIG. 3) of the first wearable electronic device.

When identifying that the signal sensitivity of the location signal is less than the threshold level in operation 1013 (operation 1013-Yes), according to an embodiment of the disclosure, the first wearable electronic device 301 may request the posture information about the second wearable electronic device 401 (e.g., the electronic device 101 of FIG. 1, the second wearable electronic device 401 of FIG. 2, and/or the second wearable electronic device 401 of FIG. 4) from the second wearable electronic device in operation 1015.

According to an embodiment of the disclosure, when identifying that the sensitivity of the location signal is less than the threshold level during the detection and recording of the movement direction of the first wearable electronic device 301 based on the location signal received from the location measurement module (e.g., the location measurement module 380 of FIG. 3) of the first wearable electronic device, the first wearable electronic device 301 may request the posture information about the second wearable electronic device 401 from the second wearable electronic device, in order to detect the movement direction of the wearable electronic device by applying the SHS as pedestrian dead reckoning.

According to an embodiment of the disclosure, in operation 1017, the second wearable electronic device 401 (e.g., the electronic device 101 of FIG. 1, the second wearable electronic device 401 of FIG. 2, and/or the second wearable electronic device 401 of FIG. 4) may transmit the posture information about the second wearable electronic device to the first wearable electronic device 301 (e.g., the electronic device 101 of FIG. 1, the first wearable electronic device 301 of FIG. 2, and/or the wearable electronic device 301 of FIG. 3).

According to an embodiment of the disclosure, when receiving the request for the posture information about the second wearable electronic device from the first wearable electronic device 301, the second wearable electronic device 401 may transmit the posture information about the second wearable electronic device to the first wearable electronic device 301 through the communication module (e.g., the second communication module 490 of FIG. 4) of the second wearable electronic device.

According to an embodiment of the disclosure, the second wearable electronic device 401 may transmit relative azimuth information calculated based on sensor information obtained from the acceleration sensor and/or gyro sensor of the sensor module (e.g., the second sensor module 476 of FIG. 4) of the second wearable electronic device or azimuth information updated based on the reference information received from the second wearable electronic device, as the posture information about the second wearable electronic device, to the first wearable electronic device 301.

According to an embodiment of the disclosure, in operation 1019, the first wearable electronic device 301 (e.g., the electronic device 101 of FIG. 1, the first wearable electronic device 301 of FIG. 2, and/or the wearable electronic device 301 of FIG. 3) may detect the movement direction of the first wearable electronic device by applying the posture information about the second wearable electronic device to pedestrian dead reckoning.

According to an embodiment of the disclosure, the first wearable electronic device 301 may detect the movement direction of the first wearable electronic device by applying the posture information (e.g., azimuth information) received from the second wearable electronic device to Equation 2 in order to detect the movement direction of the first wearable electronic device by using the SHS as pedestrian dead reckoning.

According to an embodiment of the disclosure, when identifying that the location signal received from the location measurement module (e.g., the location measurement module 380 of FIG. 3) is equal to or greater than the threshold level during the detection and recording of the movement direction of the wearable electronic device using the location measurement module (e.g., the location measurement module 380 of FIG. 3) of the first wearable electronic device 301, using the SHS, the first wearable electronic device 301 may detect and record the movement direction of the first wearable electronic device 301 based on the location signal received from the location measurement module.

According to an embodiment of the disclosure, in operation 1021, when display of a movement trajectory is requested, the first wearable electronic device 301 (e.g., the electronic device 101 of FIG. 1, the first wearable electronic device 301 of FIG. 2, and/or the wearable electronic device 301 of FIG. 3) may provide the movement trajectory (e.g., an exercise trajectory) for which the movement direction of the first wearable electronic device 301 is recorded during the execution of the location-based application.

According to an embodiment of the disclosure, when the user requests display of the movement trajectory, the first wearable electronic device 301 may control the display (e.g., the first display 360 of FIG. 3) of the first wearable electronic device to display the movement trajectory (e.g., the exercise trajectory) for which the movement direction of the first wearable electronic device 301 is recorded using the location measurement module (e.g., the location measurement module 380 of FIG. 3) of the first wearable electronic device and/or pedestrian dead reckoning (e.g., the SHS) during the execution of the location-based application.

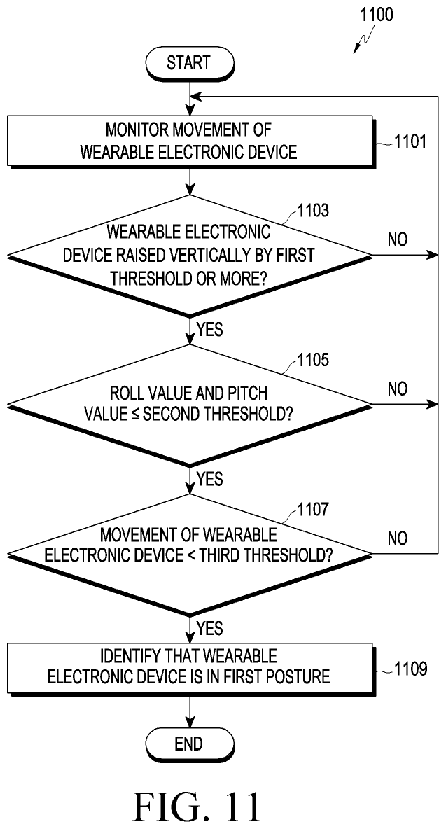

FIG. 11 is a flowchart 1100 illustrating an operation of detecting a movement direction in a wearable electronic device according to an embodiment of the disclosure. The operation of detecting a movement direction may include operations 1101 to 1109. In the following embodiment of the disclosure, each operation may be performed sequentially, but is not necessarily performed sequentially. For example, the order of the operations may be changed, at least two operations may be performed in parallel, or another operation may be added.

According to an embodiment of the disclosure, operations 1101 to 1109 may be understood as being performed by a processor (e.g., the processor 120 of FIG. 1 and/or the first processor 320 of FIG. 3) of a wearable electronic device (e.g., the electronic device 101 of FIG. 1, the first wearable electronic device 301 of FIG. 2, and/or the wearable electronic device 301 of FIG. 3).

According to an embodiment of the disclosure, in operation 1101, the wearable electronic device (e.g., the electronic device 101 of FIG. 1, the first wearable electronic device 301 of FIG. 2, and/or the wearable electronic device 301 of FIG. 3) may monitor a movement of the wearable electronic device.

According to an embodiment of the disclosure, in operation 1103, the wearable electronic device (e.g., the electronic device 101 of FIG. 1, the first wearable electronic device 301 of FIG. 2, and/or the wearable electronic device 301 of FIG. 3) may determine whether the wearable electronic device is vertically raised by a first threshold or more.

According to an embodiment of the disclosure, the wearable electronic device may determine whether the wearable electronic device 301 worn on the user's arm is vertically raised by the first threshold or more based on sensor information obtained from the acceleration sensor in the sensor module (e.g., the first sensor module 376 of FIG. 3) of the wearable electronic device.

When determining that the wearable electronic device is not vertically raised by the first threshold or more in operation 1103 (operation 1103-No), the wearable electronic device may monitor the movement of the wearable electronic device in operation 1101.

When determining that the wearable electronic device is vertically raised by the first threshold or more in operation 1103 (operation 1103-Yes), according to an embodiment of the disclosure, it may determine whether a roll value and a pitch value are equal to or less than a second threshold in operation 1105.

According to an embodiment of the disclosure, the wearable electronic device may determine whether the roll value and the pitch value calculated based on sensor information obtained from the acceleration sensor of the sensor module (e.g., the first sensor module 376 of FIG. 3) of the wearable electronic device are equal to or less than the second threshold.

When the wearable electronic device determines that the roll value and the pitch value are greater than the second threshold in operation 1105 (operation 1105
No), the wearable electronic device may monitor the movement of the wearable electronic device in operation 1101.

When the wearable electronic device determines that the roll value and the pitch value are equal to or less than the second threshold in operation 1105 (operation 1105-Yes), according to an embodiment of the disclosure, the wearable electronic device may determine whether the movement of the wearable electronic device is less than a third threshold in operation 1107.

According to an embodiment of the disclosure, the wearable electronic device may detect the movement (motion) of the wearable electronic device based on the sensor information obtained from the acceleration sensor of the sensor module (e.g., the first sensor module 376 of FIG. 3) of the wearable electronic device.

When the wearable electronic device determines that the movement of the wearable electronic device is equal to or greater than the third threshold in operation 1107 (operation 1107-No), the wearable electronic device may monitor the movement of the wearable electronic device in operation 1101.

When determining that the movement of the wearable electronic device is less than the third threshold in operation 1107 (operation 1107-Yes), according to an embodiment of the disclosure, the wearable electronic device may identify that the wearable electronic device is in a first posture in operation 1019.

According to an embodiment of the disclosure, the wearable electronic device may identify a first posture of the wearable electronic device in which the user raises the arm wearing the first wearable electronic device 301 and gazes at the display of the wearable electronic device in the state where the wearable electronic device decreases in velocity or is stationary, and identify that a time point is reached for transmitting reference information for updating posture information about an external wearable electronic device (e.g., the second wearable electronic device 401 of FIG. 2 and/or the wearable electronic device 401 of FIG. 4) to the external wearable electronic device.

A method of detecting a movement direction in a wearable electronic device (e.g., 101 of FIG. 1, 301 of FIG. 2, or 301 of FIG. 3) according to an embodiment may include, when identifying execution of a location-based application, requesting an external wearable electronic device (401 of FIG. 2 or 401 of FIG. 4) communication-connected through a communication module (390 of FIG. 3) of the wearable electronic device (101 of FIG. 1, 301 of FIG. 2, or 301 of FIG. 3) to calculate posture information about the external wearable electronic device.

The method according to an embodiment of the disclosure may include, when identifying that a reception sensitivity of a location signal received from a location measurement module of the wearable electronic device is equal to or less than a threshold level during detection of a movement direction of the wearable electronic device based on the location signal, requesting the posture information about the external wearable electronic device from the external wearable electronic device.

The method according to an embodiment of the disclosure may include detecting the movement direction of the wearable electronic device by applying the posture information received from the external wearable electronic device to pedestrian dead reckoning.

The method according to an embodiment of the disclosure may further include connecting communication to the external wearable electronic device (401 of FIG. 2 or 401 of FIG. 4) worn on a part of a user's head through the communication module (390 of FIG. 3), while the wearable electronic device (101 of FIG. 1, 301 of FIG. 2, or 301 of FIG. 3) is worn on an arm of the user.

The method according to an embodiment of the disclosure may further include, transmitting, to the external wearable electronic device, reference information calculated based on sensor information obtained from a sensor module (376 of FIG. 3) or a location signal obtained from a location measurement module (380 of FIG. 3), when identifying that a time point is reached for transmitting, to the external wearable electronic device (401 of FIG. 2 or 401 of FIG. 4), the reference information for updating the posture information calculated by the external wearable electronic device during the detection of the movement direction of the wearable electronic device based on the location signal received from the location measurement module.

The method according to an embodiment of the disclosure may include, when determining that the wearable electronic device is vertically raised by a first threshold or more based on the sensor module (376 of FIG. 3) of the wearable electronic device (101 of FIG. 1, 301 of FIG. 2, or 301 of FIG. 3), determining that a roll value and a pitch value are equal to or less than a second threshold, and determining that a movement of the wearable electronic device is less than a third threshold, identifying that the wearable electronic device is in a first posture.

The method according to an embodiment of the disclosure may include, when identifying that the wearable electronic device is in the first posture, identifying that a time point for transmitting reference information is reached.

The method according to an embodiment of the disclosure may further include, when identifying that the time point for transmitting the reference information is reached, transmitting the reference information calculated based on a sensor signal obtained from the sensor module to the external wearable electronic device.

The method according to an embodiment of the disclosure may include, when detecting that a velocity of the wearable electronic device (101 of FIG. 1, 301 of FIG. 2, or 301 of FIG. 3) is equal to or higher than a threshold velocity based on the location measurement module (380 of FIG. 3), identifying that the time point for transmitting the reference information is reached.

The method according to an embodiment of the disclosure may further include, when identifying that the time point for transmitting the reference information is reached, transmitting the reference information calculated based on the location signal obtained from the location measurement module to the external wearable electronic device.

The method according to an embodiment of the disclosure may include calculating absolute azimuth information based on the sensor signal obtained from the sensor module (376 of FIG. 3) or the location signal obtained from the location measurement module.

The method according to an embodiment of the disclosure may further include transmitting the absolute azimuth information as the reference information to the external wearable electronic device (401 of FIG. 2 or 401 of FIG. 4).

A method of detecting a movement direction according to an embodiment of the disclosure may include, when identifying execution of a location-based application, requesting a communication-connected second wearable electronic device to calculate posture information about the second wearable electronic device by a first wearable electronic device (101 of FIG. 1, 301 of FIG. 2, or 301 of FIG. 3).

The method according to an embodiment of the disclosure may include, when receiving the request for calculating the posture information about the second wearable electronic device from the first wearable electronic device, calculating the posture information about the second wearable electronic device based on a sensor module (476 of FIG. 4) of the second wearable electronic device by the second wearable electronic device (401 of FIG. 2 and 401 of FIG. 4).

The method according to an embodiment of the disclosure may include, when identifying that a reception sensitivity of a location signal received from a location measurement module (380 of FIG. 3) of the first wearable electronic device is equal to or less than a threshold during detection of a movement direction of the first wearable electronic device based on the location signal, requesting the posture information about the second wearable electronic device from the second wearable electronic device by the first wearable electronic device.

The method according to an embodiment of the disclosure may include, when receiving the request for the posture information about the second wearable electronic device from the first wearable electronic device, transmitting the posture information about the second wearable electronic device to the first wearable electronic device by the second wearable electronic device.

The method according to an embodiment of the disclosure may include detecting the movement direction of the first wearable electronic device by applying the posture information received from the second wearable electronic device to pedestrian dead reckoning by the first wearable electronic device.

The method according to an embodiment of the disclosure may further include, when identifying that a time point is reached for transmitting, to the second wearable electronic device, reference information for updating the posture information calculated by the second wearable electronic device during detection of the movement direction of the first wearable electronic device based on the location signal from the location measurement module (380 of FIG. 3), transmitting, to the second wearable electronic device (401 of FIG. 2 and 401 of FIG. 2), the reference information calculated based on a sensor signal obtained from a sensor module of the first wearable electronic device or the location signal obtained from the location measurement module by the first wearable electronic device (101 of FIG. 1, 301 of FIG. 2, or 301 of FIG. 3).

The method according to an embodiment of the disclosure may further include, when receiving the reference information from the first wearable electronic device (101 of FIG. 1, 301 of FIG. 2, or 301 of FIG. 3), updating the posture information calculated by the second wearable electronic device based on the reference information by the second wearable electronic device (401 of FIG. 2 and 401 of FIG. 4).

In the method according to an embodiment of the disclosure, the reference information received by the second wearable electronic device (401 of FIG. 2 and 401 of FIG. 4) may include absolute azimuth information, and the posture information calculated by the second wearable electronic device may include relative azimuth information.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment of the disclosure, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101 or the electronic device 301). For example, a processor (e.g., the processor 520) of the machine (e.g., the electronic device 301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment of the disclosure, each component (e.g., a module or a program) of the above-described components may include a single entity or multiple entities, and some of the multiple entities may be separately disposed in different components. According to an embodiment of the disclosure, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment of the disclosure, operations performed by the module, the program, or another component may be carried out sequentially, in parallel, repeatedly, or heuristically, or one or more of the operations may be executed in a different order or omitted, or one or more other operations may be added.

According to an embodiment of the disclosure, in a non-volatile storage medium storing instructions, the instructions may be configured to, when executed by an electronic device, cause the electronic device to perform at least one operation. The at least one operation may include, when identifying execution of a location-based application, request an external wearable electronic device communication-connected through a communication module of the wearable electronic device to calculate posture information about the external wearable electronic device, when identifying that a reception sensitivity of a location signal received from a location measurement module of the wearable electronic device is equal to or less than a threshold level during detection of a movement direction of the wearable electronic device based on the location signal, requesting the posture information about the external wearable electronic device from the external wearable electronic device, and detecting the movement direction of the wearable electronic device by applying the posture information received from the external wearable electronic device to pedestrian dead reckoning.

According to an embodiment of the disclosure, in a non-volatile storage medium storing instructions, the instructions may be configured to, when executed by an electronic device, cause the electronic device to perform at least one operation. The at least one operation may include, when identifying execution of a location-based application, requesting a communication-connected second wearable electronic device to calculate posture information about the second wearable electronic device by a first wearable electronic device, when receiving the request for calculating the posture information about the second wearable electronic device from the first wearable electronic device, calculating the posture information about the second wearable electronic device based on a sensor module of the second wearable electronic device by the second wearable electronic device, when identifying that a reception sensitivity of a location signal received from a location measurement module of the first wearable electronic device is equal to or less than a threshold during detection of a movement direction of the first wearable electronic device based on the location signal, requesting the posture information about the second wearable electronic device from the second wearable electronic device by the first wearable electronic device, when receiving the request for the posture information about the second wearable electronic device from the first wearable electronic device, transmitting the posture information about the second wearable electronic device to the first wearable electronic device by the second wearable electronic device, and detecting the movement direction of the first wearable electronic device by applying the posture information received from the second wearable electronic device to pedestrian dead reckoning by the first wearable electronic device.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device comprising:
a sensor module;
a location measurement module;
a communication module;
memory storing one or more computer programs; and
one or more processors communicatively coupled to the sensor module, the location measurement module, the communication module, and the memory,
wherein the one or more computer programs include computer-executable instructions that, when executed by the one or more processors individually or collectively, cause the wearable electronic device to:
when identifying execution of a location-based application, request an external wearable electronic device communication-connected through the communication module to calculate posture information about the external wearable electronic device,
when identifying that a reception sensitivity of a location signal received from the location measurement module is equal to or less than a threshold level during detection of a movement direction of the wearable electronic device based on the location signal, request the posture information about the external wearable electronic device from the external wearable electronic device, and
detect the movement direction of the wearable electronic device by applying the posture information received from the external wearable electronic device to pedestrian dead reckoning.

2. The wearable electronic device of claim 1, wherein the one or more computer programs further include computer-executable instructions that, when executed by the one or more processors individually or collectively, cause the wearable electronic device to:
connect communication to the external wearable electronic device worn on a part of a user's head through the communication module, while the wearable electronic device is worn on a user's arm.

3. The wearable electronic device of claim 1, wherein the one or more computer programs further include computer-executable instructions that, when executed by the one or more processors individually or collectively, cause the wearable electronic device to:
transmit, to the external wearable electronic device, reference information calculated based on sensor information obtained from the sensor module or the location signal obtained from the location measurement module, when identifying that a time point is reached for transmitting, to the external wearable electronic device, the reference information for updating the posture information calculated by the external wearable electronic device during the detection of the movement direction of the wearable electronic device based on the location signal received from the location measurement module.

4. The wearable electronic device of claim 3, wherein the one or more computer programs further include computer-executable instructions that, when executed by the one or more processors individually or collectively, cause the wearable electronic device to:
when determining that the wearable electronic device is vertically raised by a first threshold or more based on the sensor module, determining that a roll value and a pitch value are equal to or less than a second threshold, and determining that a movement of the wearable electronic device is less than a third threshold, identify that the wearable electronic device is in a first posture,
when identifying the first posture, identify that the time point for transmitting the reference information is reached; and
when identifying that the time point for transmitting the reference information is reached, transmit the reference information calculated based on a sensor signal obtained from the sensor module to the external wearable electronic device.

5. The wearable electronic device of claim 3, wherein the one or more computer programs further include computer-executable instructions that, when executed by the one or more processors individually or collectively, cause the wearable electronic device to:
when detecting that a velocity of the wearable electronic device is equal to or higher than a threshold velocity based on the location measurement module, identify that the time point for transmitting the reference information is reached, and
when identifying that the time point for transmitting the reference information is reached, transmit the reference information calculated based on the location signal obtained from the location measurement module to the external wearable electronic device.

6. The wearable electronic device of claim 3, wherein the one or more computer programs further include computer-executable instructions that, when executed by the one or more processors individually or collectively, cause the wearable electronic device to:
calculate absolute azimuth information based on the sensor signal obtained from the sensor module or the location signal obtained from the location measurement module, and
transmit the absolute azimuth information as the reference information to the external wearable electronic device.

7. A system for detecting a movement direction, the system comprising:
a first wearable electronic device configured to:
when identifying execution of a location-based application, request a communication-connected second wearable electronic device to calculate posture information about the second wearable electronic device,
when identifying that a reception sensitivity of a location signal received from a location measurement module of the first wearable electronic device is equal to or less than a threshold during detection of a movement direction of the first wearable electronic device based on the location signal, request the posture information about the second wearable electronic device from the second wearable electronic device, and
detect the movement direction of the first wearable electronic device by applying the posture information received from the second wearable electronic device to pedestrian dead reckoning; and
the second wearable electronic device configured to:
when receiving the request for calculating the posture information about the second wearable electronic device from the first wearable electronic device, calculate the posture information about the second wearable electronic device based on a sensor module of the second wearable electronic device, and
when receiving the request for the posture information about the second wearable electronic device from the first wearable electronic device, transmit the posture information about the second wearable electronic device to the first wearable electronic device.

8. The system of claim 7, wherein, when identifying that a time point is reached for transmitting, to the second wearable electronic device, reference information for updating the posture information about the second wearable electronic device during detection of the movement direction of the first wearable electronic device based on the location signal from the location measurement module, the first wearable electronic device is configured to transmit, to the second wearable electronic device, the reference information calculated based on a sensor signal obtained from a sensor module of the first wearable electronic device or the location signal obtained from the location measurement module.

9. The system of claim 8,
wherein, when receiving the reference information from the first wearable electronic device, the second wearable electronic device is configured to update the posture information calculated by the second wearable electronic device,
wherein the reference information received by the second wearable electronic device includes absolute azimuth information, and
wherein the posture information calculated by the second wearable electronic device includes relative azimuth information.

10. A method of detecting a movement direction in a wearable electronic device, the method comprising:
when identifying execution of a location-based application, requesting an external wearable electronic device communication-connected through a communication module of the wearable electronic device to calculate posture information about the external wearable electronic device;
when identifying that a reception sensitivity of a location signal received from a location measurement module of the wearable electronic device is equal to or less than a threshold level during detection of a movement direction of the wearable electronic device based on the location signal, requesting the posture information about the external wearable electronic device from the external wearable electronic device; and
detecting the movement direction of the wearable electronic device by applying the posture information received from the external wearable electronic device to pedestrian dead reckoning.

11. The method of claim 10, further comprising:
when determining that the wearable electronic device is vertically raised by a first threshold or more based on a sensor module of the wearable electronic device, determining that a roll value and a pitch value are equal to or less than a second threshold, and determining that a movement of the wearable electronic device is less than a third threshold, identifying that the wearable electronic device is in a first posture;
when identifying that the wearable electronic device is in the first posture, identifying that a time point for transmitting reference information is reached; and
when identifying that the time point for transmitting the reference information is reached, transmitting the reference information calculated based on a sensor signal obtained from the sensor module to the external wearable electronic device.

12. The method of claim 11, further comprising:
when detecting that a velocity of the wearable electronic device is equal to or higher than a threshold velocity based on the location measurement module, identifying that a time point for transmitting the reference information is reached; and
when identifying that the time point for transmitting the reference information is reached, transmitting the reference information calculated based on the location signal obtained from the location measurement module to the external wearable electronic device.

13. A method of detecting a movement direction, the method comprising:
when identifying execution of a location-based application, requesting a communication-connected second wearable electronic device to calculate posture information about the second wearable electronic device by a first wearable electronic device;
when receiving the request for calculating the posture information about the second wearable electronic device from the first wearable electronic device, calculating the posture information about the second wearable electronic device based on a sensor module of the second wearable electronic device by the second wearable electronic device;
when identifying that a reception sensitivity of a location signal received from a location measurement module of the first wearable electronic device is equal to or less than a threshold during detection of a movement direction of the first wearable electronic device based on the location signal, requesting the posture information about the second wearable electronic device from the second wearable electronic device by the first wearable electronic device;
when receiving the request for the posture information about the second wearable electronic device from the first wearable electronic device, transmitting the posture information about the second wearable electronic device to the first wearable electronic device by the second wearable electronic device; and
detecting the movement direction of the first wearable electronic device by applying the posture information received from the second wearable electronic device to pedestrian dead reckoning by the first wearable electronic device.

14. The method of claim 13, further comprising:
when identifying that a time point is reached for transmitting, to the second wearable electronic device, reference information for updating the posture information calculated by the second wearable electronic device during detection of the movement direction of the first wearable electronic device based on the location signal from the location measurement module, transmitting, to the second wearable electronic device, the reference information calculated based on a sensor signal obtained from a sensor module of the first wearable electronic device or the location signal obtained from the location measurement module by the first wearable electronic device.

15. The method of claim 13, further comprising:
when receiving the reference information from the first wearable electronic device, updating the posture information calculated by the second wearable electronic device based on the reference information by the second wearable electronic device,
wherein the reference information received by the second wearable electronic device includes absolute azimuth information, and
wherein the posture information calculated by the second wearable electronic device includes relative azimuth information.

16. One or more non-transitory computer-readable storage media storing one or more computer programs including computer-executable instructions that, when executed by one or more processors of an electronic device individually or collectively, cause the electronic device to perform operations of detecting a movement direction, the operations comprising:
when identifying execution of a location-based application, requesting a communication-connected second wearable electronic device to calculate posture information about the second wearable electronic device by a first wearable electronic device;
when receiving the request for calculating the posture information about the second wearable electronic device from the first wearable electronic device, calculating the posture information about the second wearable electronic device based on a sensor module of the second wearable electronic device by the second wearable electronic device;
when identifying that a reception sensitivity of a location signal received from a location measurement module of the first wearable electronic device is equal to or less than a threshold during detection of a movement direction of the first wearable electronic device based on the location signal, requesting the posture information about the second wearable electronic device from the second wearable electronic device by the first wearable electronic device;
when receiving the request for the posture information about the second wearable electronic device from the first wearable electronic device, transmitting the posture information about the second wearable electronic device to the first wearable electronic device by the second wearable electronic device; and
detecting the movement direction of the first wearable electronic device by applying the posture information received from the second wearable electronic device to pedestrian dead reckoning by the first wearable electronic device.

17. The one or more non-transitory computer-readable storage media of claim 16, the operations further comprising:
when identifying that a time point is reached for transmitting, to the second wearable electronic device, reference information for updating the posture information calculated by the second wearable electronic device during detection of the movement direction of the first wearable electronic device based on the location signal from the location measurement module, transmitting, to the second wearable electronic device, the reference information calculated based on a sensor signal obtained from a sensor module of the first wearable electronic device or the location signal obtained from the location measurement module by the first wearable electronic device.

18. The one or more non-transitory computer-readable storage media of claim 16, the operations further comprising:
when receiving the reference information from the first wearable electronic device, updating the posture information calculated by the second wearable electronic device based on the reference information by the second wearable electronic device,
wherein the reference information received by the second wearable electronic device includes absolute azimuth information, and
wherein the posture information calculated by the second wearable electronic device includes relative azimuth information.
